(19) United States
(12) Patent Application Publication
(10) Pub. No.: US 2007/0191075 A1
(43) Pub. Date: Aug. 16, 2007

(54) Implementation of an RF power transmitter and network

(75) Inventors: Charles E. Greene, Cabot, PA (US); Daniel W. Harrist, Carnegie, PA (US); John G. Shearer, Ligonier, PA (US); Michele Migliuolo, Pittsburgh, PA (US); Gregory W. Puschnigg, Ligonier, PA (US)

Correspondence Address: Ansel M. Schwartz;Attorney at Law, Suite 304, 201 N. Craig Street, Pittsburgh, PA, 15213, US

(73) Assignee: Powercast, LLC

(21) Appl. No.: 11/705,303

(22) Filed: Feb. 12, 2007

Related U.S. Application Data
(60) Provisional application No. 60/773,036, filed on Feb. 13, 2006.

(51) Int. Cl. H04B 1/10; H04B 1/38

(52) U.S. Cl. 455/572; 455/299

(57) ABSTRACT

Disclosed is a power transmission system for wirelessly powering a power harvesting device. The system comprises at least one RF power transmitter. The system includes an AC power grid, or a DC grid to which the transmitter is electrically connected. Also disclosed is an adjustable RF power transmitter for powering wirelessly an RF power harvesting- device. Also disclosed is a power transmission system for wirelessly powering an RF power harvesting device. The system can include a computer with an antenna or a lighting fixture or a light or a battery charging unit or a battery. Also disclosed is an apparatus for wirelessly powering a power harvesting device. Also disclosed is a method for wirelessly powering a power harvesting device.

### BACKGROUND OF THE INVENTION

1. Field of the Invention

The present invention is related to transmitting wirelessly power to a power harvesting device. More specifically, the present invention is related to implementing a power transmitter for the wireless transmission of power to a power harvesting device.

2. Description of Related Art

As processor capabilities have expanded and power requirements have decreased there has been an ongoing explosion of devices that operate completely independent of wires or power cords. These “untethered” devices range from cell phones and wireless keyboards to building sensors and active Radio Frequency Identification (RFID) tags.

Engineers and designers of these untethered devices continue to have to deal with the limitations of portable power sources, primarily using batteries as the key design parameter. While the performance of processors and portable devices has been doubling every 18-24 months driven by Moore's law, battery technology in terms of capacity has only been growing at measly 6% per year. Even with power conscious designs and the latest in battery technology, many devices do not meet the lifetime cost and maintenance requirements for applications that require a large number of untethered devices, such as logistics and building automation. Today's devices that need two-way communication require scheduled maintenance every three to 18 months to replace or recharge the device's power source (typically a battery). One-way devices that simply broadcast their status without receiving any signals, such as automated utility meter readers, have a better battery life typically requiring replacement within 10 years. For both device types, scheduled power-source maintenance is costly and can be disruptive to the entire system that the device is intended to monitor and/or control. Unscheduled maintenance trips are even more costly and disruptive. On a macro level, the relatively high cost associated with the internal battery also reduces the practical, or economically viable, number of devices that can be deployed.

The ideal solution to the power problem for untethered devices is a device or system that can collect and harness sufficient energy from the environment. This energy can be harnessed from many different sources, such as sunlight, vibration, heat, or electro-magnetic radiation. The harnessed energy would then either directly power an untethered device or augment a power supply. However, this ideal solution may not always be practical to implement due to low energy in the environment, and site restrictions may limit the ability to use a dedicated energy supply. The proposed invention takes these factors into account and provides a solution for both the ideal situation and also for more restrictive circumstances.

### BRIEF SUMMARY OF THE INVENTION

The present invention pertains to a power transmission system for wirelessly powering a power harvesting device. The system comprises at least one RF power transmitter. The system comprises an AC power grid to which the transmitter is electrically connected.

The power grid can have an outlet. The transmitter can have a cord which plugs into the outlet. The transmitter can plug directly into the outlet. The power grid can have a light. The transmitter can include an AC to DC converter that can convert the AC power obtained from the grid to a usable DC voltage or current.

The present invention pertains to a power transmission system for wirelessly powering a power harvesting device. The system comprises at least one RF power transmitter. The system comprises a DC power grid to which the transmitter is electrically connected.

The present invention pertains to an adjustable RF power transmitter for powering wirelessly an RF power harvesting device. The transmitter comprises a housing having outer dimensions no greater than 3″×3″ by 8 inches. The transmitter comprises a power input. The transmitter comprises a frequency generator in communication with the power input. The transmitter comprises an amplifier in communication with the frequency generator. The transmitter comprises a controller connected with the frequency generator. The transmitter comprises an antenna connected to the amplifier.

The present invention pertains to a power transmission system for wirelessly powering an RF power harvesting device. The system comprises a computer with an antenna. The system comprises an RF transmitter in communication with the antenna. The system comprises a power supply in electrical communication with the RF transmitter and the computer.

The present invention pertains to an apparatus for wirelessly powering a power harvesting device. The apparatus comprises at least one RF power transmitter. The apparatus comprises a lighting fixture in which the transmitter is disposed and from which the transmitter receives power.

The lighting fixture can be a fluorescent lighting fixture. The lighting fixture can be an incandescent lighting fixture. The apparatus can include a light source in electrical communication with the lighting fixture.

The present invention pertains to a power transmission system for wirelessly powering a power harvesting device. The system comprises at least one RF power transmitter. The system comprises a track supplying power to which the transmitter is electrically connected.

The present invention pertains to a power transmission system for wirelessly powering a power harvesting device. The system comprises at least one RF power transmitter. The system comprises a battery charging unit to which the transmitter is electrically connected.

The present invention pertains to a power transmission system for wirelessly powering a power harvesting device. The system comprises at least one RF power transmitter. The system comprises at least one rechargeable battery to which the transmitter is electrically connected.

The present invention pertains to a method for wirelessly powering a power harvesting device. The method comprises the steps of electrically connecting at least one RF power transmitter to an AC power grid. There is the step of transmitting power with the RF power transmitter.

The present invention pertains to a method for wirelessly powering a power harvesting device. The method comprises the steps of electrically connecting at least one RF power transmitter to a DC power grid. There is the step of transmitting power with the RF power transmitter.

The present invention pertains to a method for wirelessly powering a power harvesting device. The method comprises the steps of electrically connecting a power supply with an RF transmitter and a computer. There is the step of transmitting power with the RF power transmitter.

The present invention pertains to a method for wirelessly powering a power harvesting device. The method comprises the steps of electrically connecting at least one RF power transmitter with a lighting fixture in which the transmitter is disposed and from which the transmitter receives power. There is the step of transmitting power with the RF power transmitter.

The present invention pertains to a method for wirelessly powering a power harvesting device. The method comprises the steps of electrically connecting at least one RF power transmitter to a battery charging unit. There is the step of transmitting power with the RF power transmitter.

The present invention pertains to a power transmission system for wirelessly powering a power harvesting device. The system comprises at least one RF power transmitter. The system comprises means for providing power to which the transmitter is electrically connected.

The present invention pertains to an apparatus for wirelessly powering a power harvesting device from a DC power outlet of a vehicle, as shown in FIG. 11. The apparatus comprises an RF power transmitter. The apparatus comprises a power plug to which the transmitter is attached and electrically connected that plugs into the DC power outlet.

The present invention pertains to an apparatus for wirelessly powering a power harvesting device from an AC power grid having an AC power outlet. The apparatus comprises an RF power transmitter. The apparatus comprises a power plug to which the transmitter is electrically connected that electrically connects with the AC power outlet.

The present invention pertains to an apparatus for wirelessly powering a power harvesting device from a DC power outlet of a DC grid. The apparatus comprises an RF power transmitter. The apparatus comprises a power plug to which the transmitter is electrically connected that electrically connects with the DC power outlet.

The present invention pertains to an apparatus for wirelessly powering a power harvesting device from a computer having an antenna and a power supply. The apparatus comprises an RF power transmitter. The apparatus comprises a power plug to which the transmitter is electrically connected that electrically connects with the computer.

The present invention pertains to an apparatus for wirelessly powering a power harvesting device from a light fixture. The apparatus comprises an RF power transmitter. The apparatus comprises an electrical interface to which the transmitter is electrically connected that electrically connects with the light fixture.

The present invention pertains to an apparatus for wirelessly powering a power harvesting device from a track having at least one light. The apparatus comprises an RF power transmitter. The apparatus comprises an electrical interface to which the transmitter is electrically connected that electrically connects with the track.

The present invention pertains to an apparatus for wirelessly powering a power harvesting device from a battery charging unit. The apparatus comprises an RF power transmitter. The apparatus comprises an electrical interface to which the transmitter is electrically connected that electrically connects with the battery charging unit.

### BRIEF DESCRIPTION OF THE SEVERAL VIEWS OF THE DRAWINGS

FIG. 1 is an illustration of an RF power transmitter integrated into an RF power network via direct hardwiring to an AC power grid;

FIG. 2 is an illustration of an RF power transmitter integrated into a vehicle;

FIG. 3 is an illustration of an RF power transmitter;

FIG. 4 is an illustration of an RF power transmitter integrated into an RF power network via replacing an AC outlet on an AC power grid;

FIG. 5 is an illustration of an RF power transmitter integrated into an RF power network via replacing a light source;

FIG. 6 is an illustration of an RF power transmitter integrated into an RF power network via use in combination with a light source;

FIG. 7 is an illustration of an RF power transmitter integrated into an RF power network via integration of the RF power transmitter and a light source;

FIG. 8 is an illustration of a lighting fixture containing an RF power transmitter;

FIG. 9 is an illustration of an RF power transmitter integrated into an RF power network via connection to an AC outlet through a cord;

FIG. 10 is an illustration of an RF power transmitter integrated into an RF power network via direct connection with an AC outlet;

FIG. 11 is an illustration of an RF power transmitter that plugs into a DC power outlet in a vehicle;

FIG. 12 is an illustration of an RF power transmitter and battery recharger integrated into an RF power network via direct connection with an AC outlet;

FIG. 13 is an illustration of an RF power transmitter plugged into a USB port of a laptop computer;

FIG. 14 is an illustration of an RF powered RF power transmitter used to relay power;

FIG. 15 is an illustration of RF power transmitters integrated into an RF power network connected to a track that provides AC or DC power;

FIGS. 16a-d are illustrations of various tracks useable with the network illustrated in FIG. 15; and

FIG. 17 is an illustration of an RF power transmitter useable with a two-cable track.

### DETAILED DESCRIPTION OF THE INVENTION

A complete understanding of the invention will be obtained from the following description when taken in connection with the accompanying drawing figures wherein like reference characters identify like parts throughout.

For purposes of the description hereinafter, the terms “upper”, “lower”, “right”, “left”, “vertical”, “horizontal”, “top”, “bottom”, and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

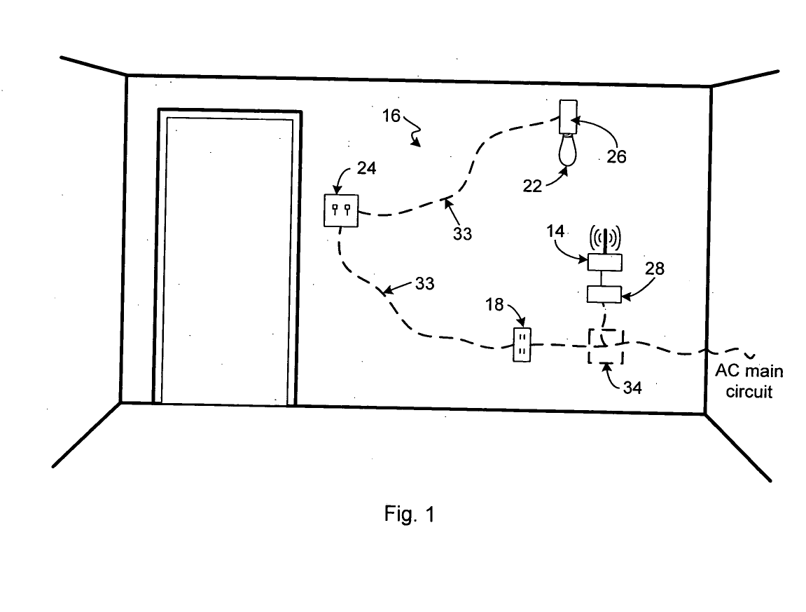

The present invention pertains to a power transmission system 10 for wirelessly powering a power harvesting device 12, as shown in FIG. 1. The system 10 comprises at least one RF power transmitter 14. The system 10 comprises an AC power grid 16 to which the transmitter 14 is electrically connected.

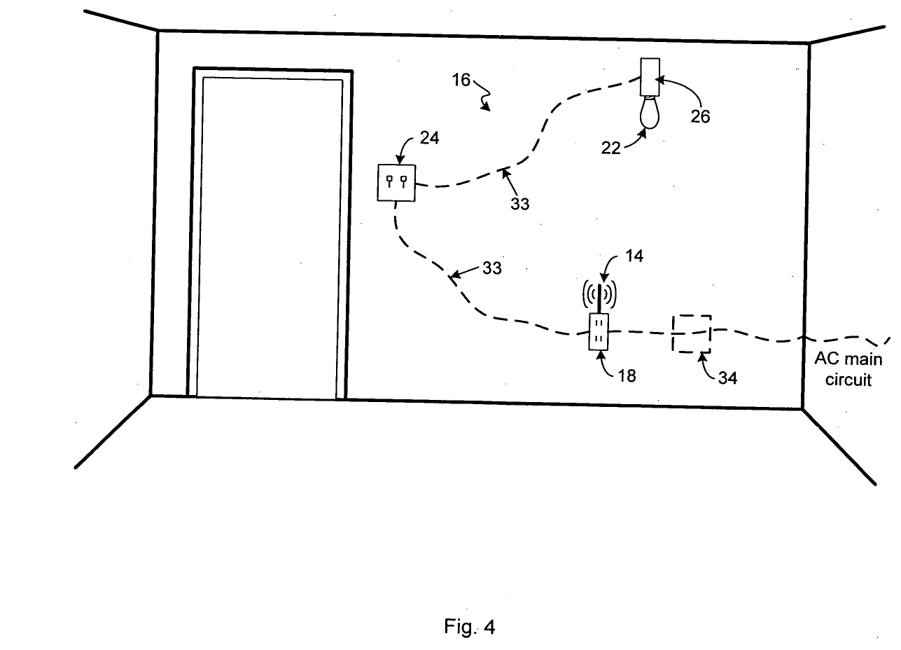

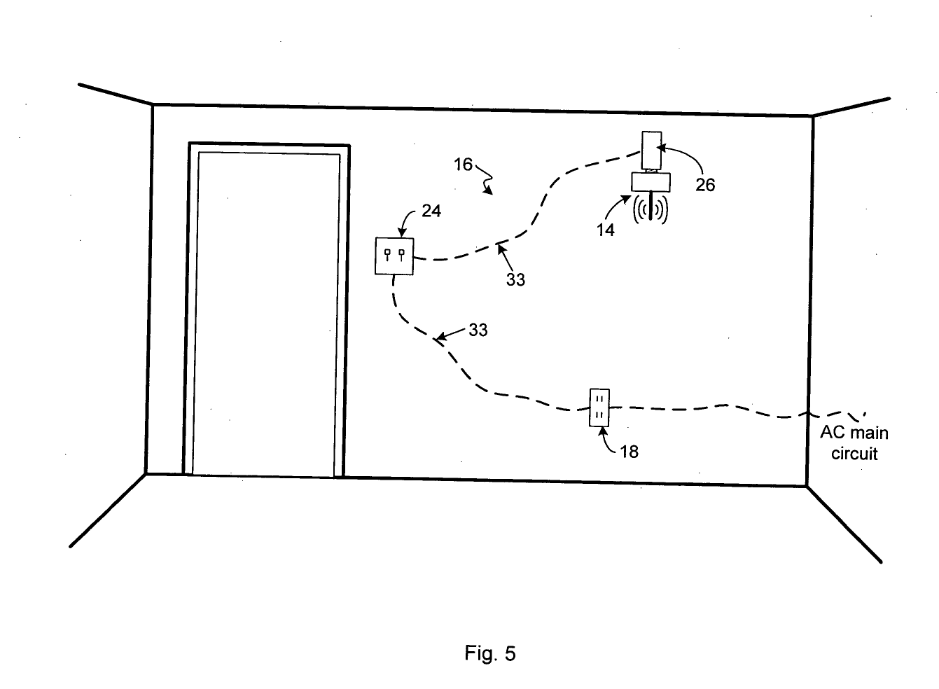

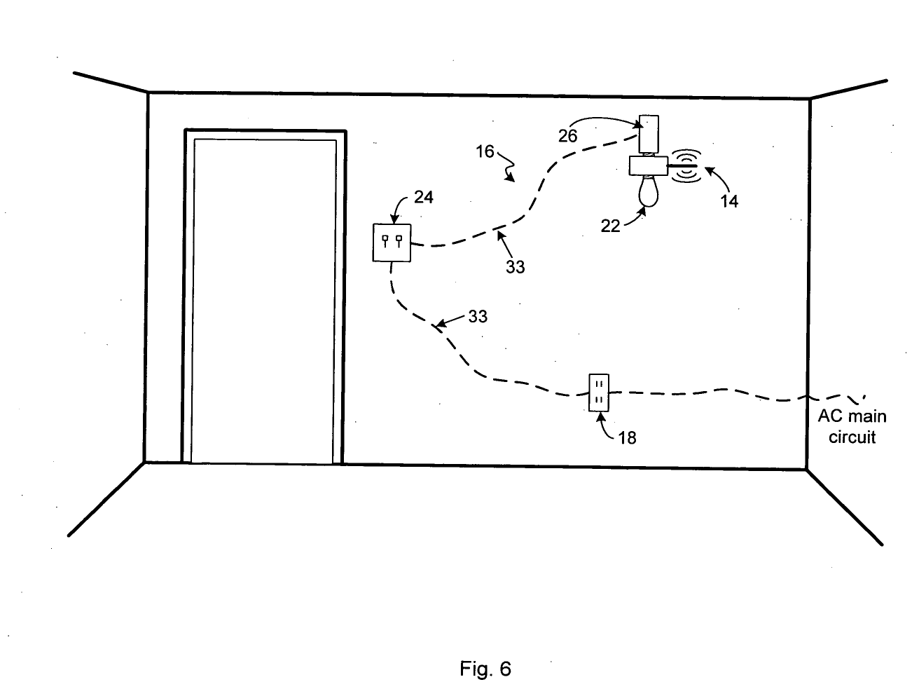

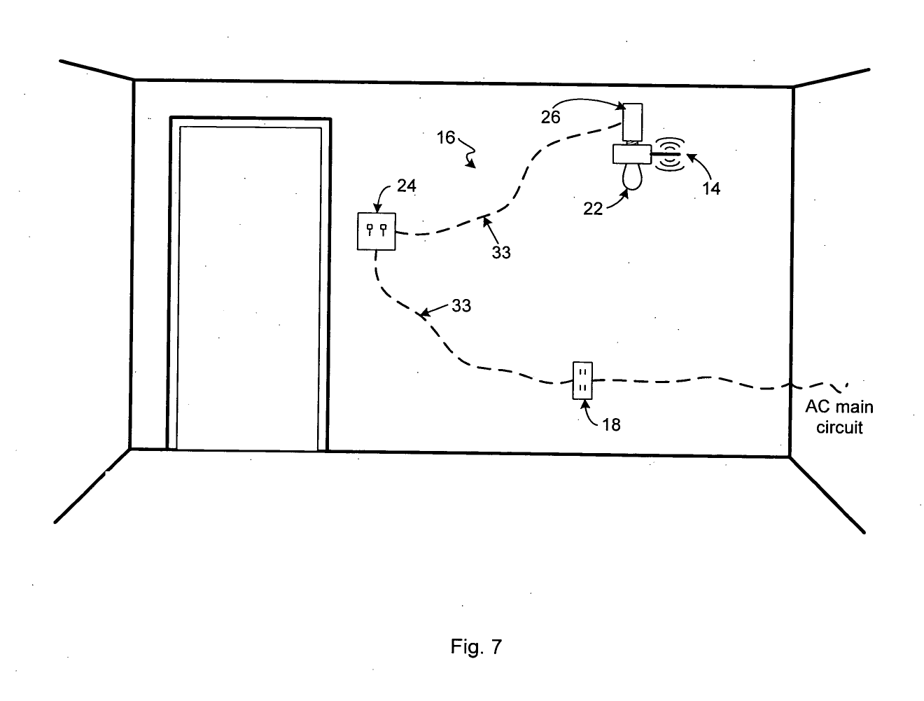

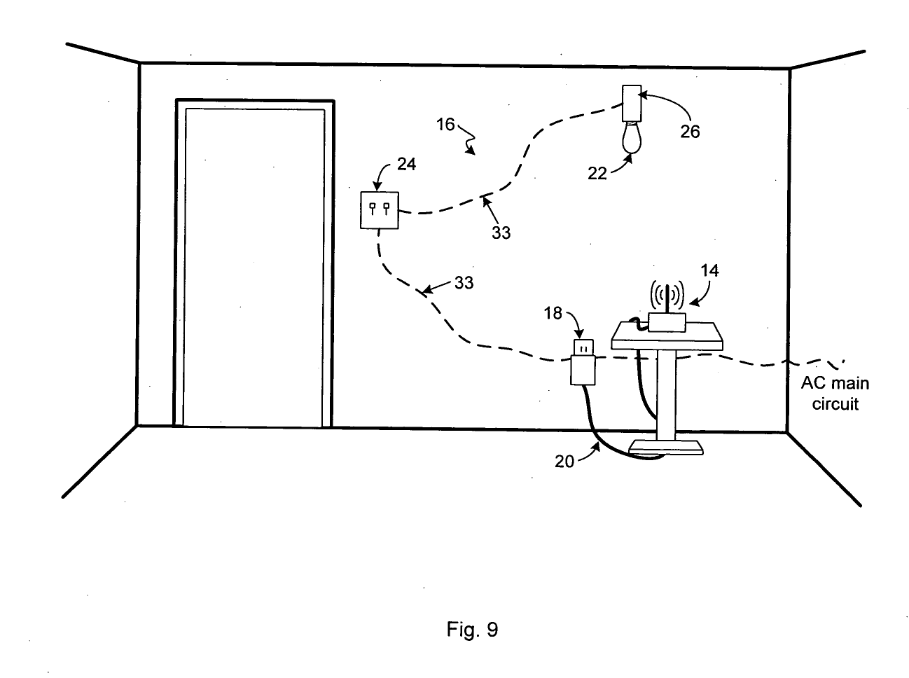

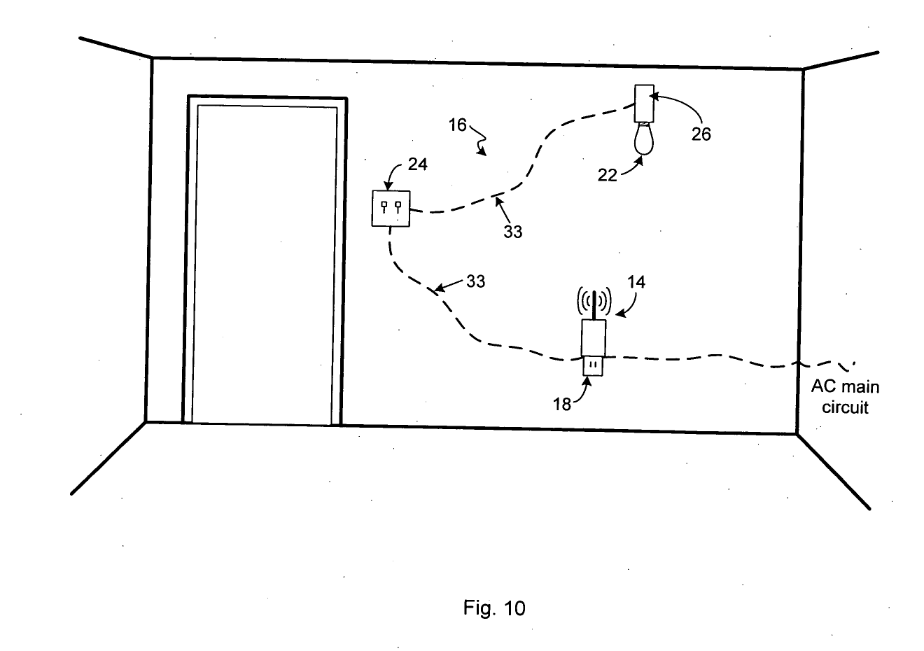

The power grid can have an outlet 18. The transmitter 14 can have a cord 20 which plugs into the outlet 18, as shown in FIG. 9. The transmitter 14 can plug directly into the outlet 18, as shown in FIG. 10. The power grid can have a light 22, as shown in FIG. 1. The transmitter 14 can include an AC to DC converter 28 that can convert the AC power obtained from the grid to a usable DC voltage or current. Preferably, the power grid has a light switch 24 to turn on the light 22. The grid preferably includes in wall wiring 33. The transmitter 14 can be integrated with the outlet 18, as shown in FIG. 4. The grid can have a lighting fixture 26 and the transmitter 14 contacts the fixture 26, as shown in FIG. 5. The grid can have a lighting fixture 26 and the light 22 and the transmitter 14 can contact the fixture, as shown in FIGS. 6 and 7.

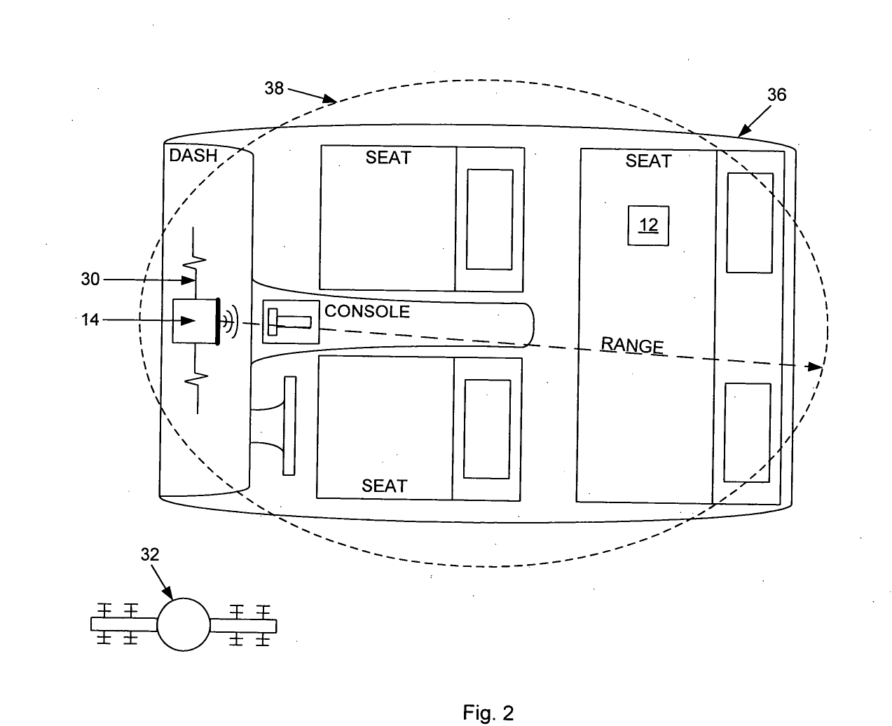

The grid can include a utility pole 32 to which the transmitter 14 is in contact, as shown in FIG. 2. The grid can include a junction box 34 to which transmitter 14 is in contact, as shown in FIG. 1.

The present invention pertains to a power transmission system 10 for wirelessly powering a power harvesting device 12, as shown in FIG. 2. The system 10 comprises at least one RF power transmitter 14. The system 10 comprises a DC power grid 30 to which the transmitter 14 is electrically connected.

Preferably, the transmitter 14 is disposed in a vehicle 36. The transmitter 14 can provide a coverage area 38 over the cabin of the vehicle 36. The transmitter 14 can be in contact with the dash, trunk, cabin, ceiling, or engine compartment of the vehicle 36.

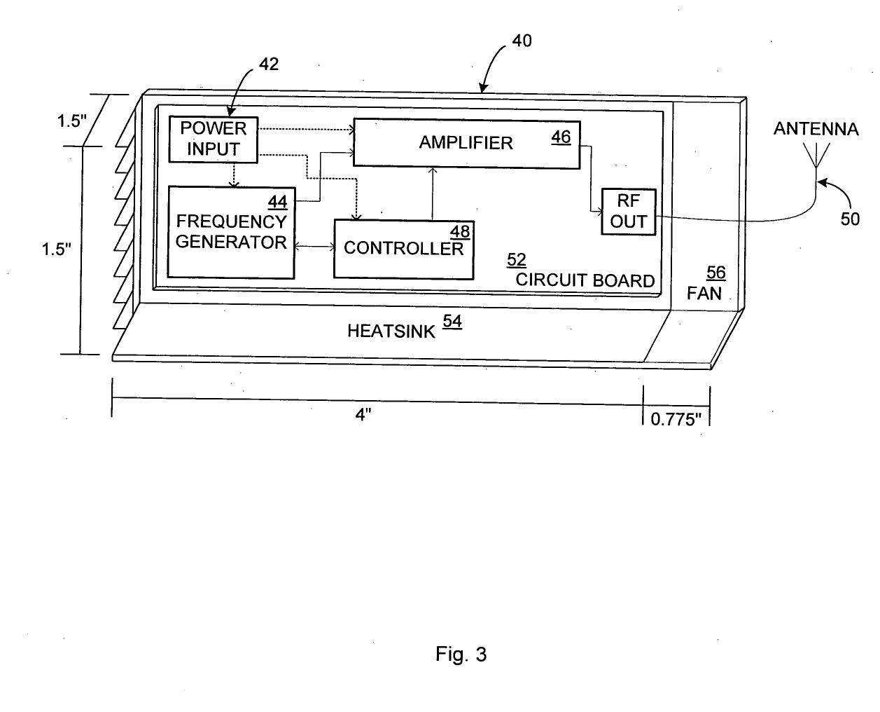

The present invention pertains to an adjustable RF power transmitter 14 for powering wirelessly an RF power harvesting device 12, as shown in FIG. 3. The transmitter 14 comprises a housing 40 having outer dimensions no greater than 3″×3″ by 8 inches. The transmitter 14 comprises a power input 42. The transmitter 14 comprises a frequency generator 44 in communication with the power input 42. The transmitter 14 comprises an amplifier 46 in communication with the frequency generator 44. The transmitter 14 comprises a controller 48 connected with the frequency generator 44. The transmitter 14 comprises an antenna 50 connected to the amplifier 46.

The transmitter 14 can include a circuit board 52 on which the power input 42, the frequency generator 44 and the amplifier 46 are disposed. The transmitter 14 can include a heat sink 54 in contact with the circuit board 52. The transmitter 14 can include a fan 56 disposed adjacent the circuit board 52.

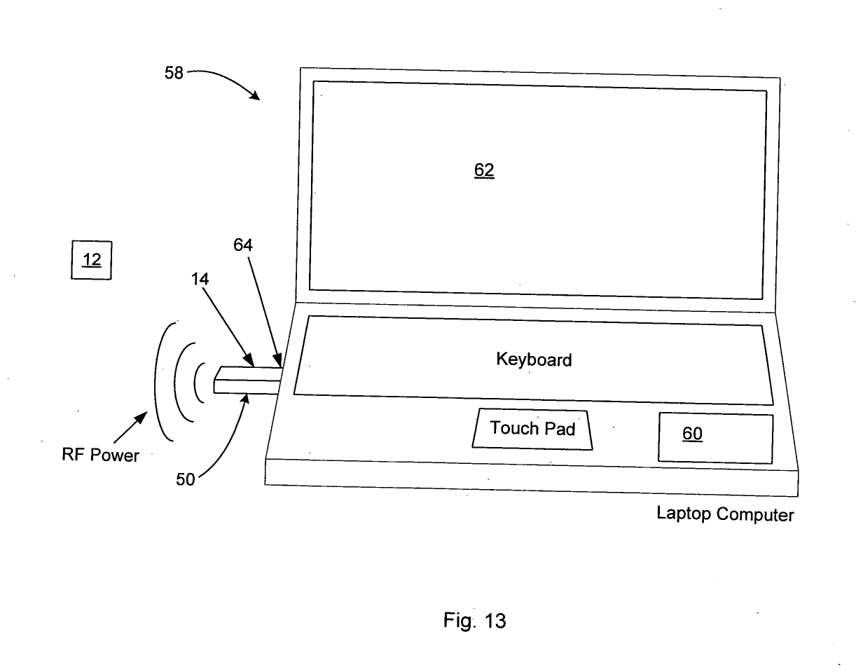

The present invention pertains to a power transmission system 10 for wirelessly powering an RF power harvesting device 12, as shown in FIG. 13. The system 10 comprises a computer 58 with an antenna 50. The system 10 comprises an RF transmitter 14 in communication with the antenna 50. The system 10 comprises a power supply 60 in electrical communication with the RF transmitter 14 and the computer 58.

Preferably, the RF transmitter 14 is connected to the computer 58. The computer 58 can have a power port 64, and the transmitter 14 is plugged into the power port 64. The power port 64 can be a USB port 64. The antenna 50 can be integrated with the transmitter 14. Alternatively, the system 10 can include a display 62, and the antenna 50 is in contact with the display 62.

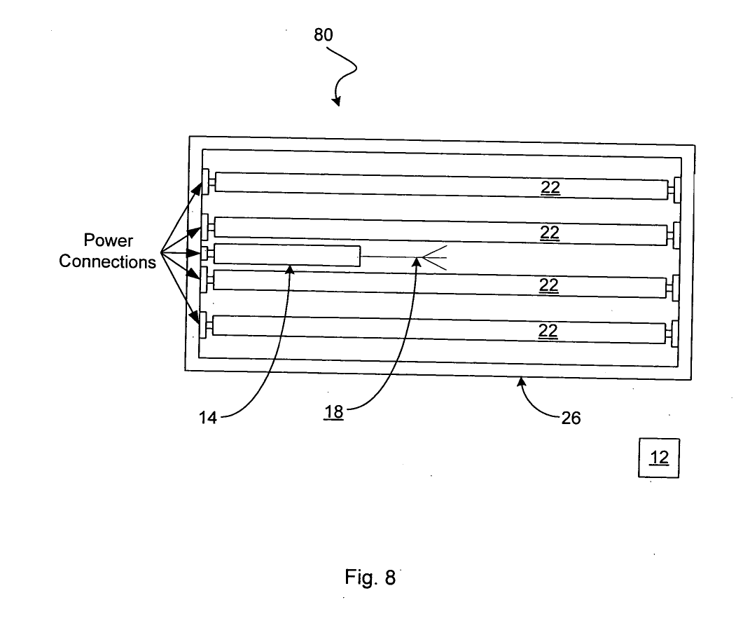

The present invention pertains to an apparatus 80 for wirelessly powering a power harvesting device 12, as shown in FIG. 8. The apparatus 80 comprises at least one RF power transmitter 14. The apparatus 80 comprises a lighting fixture 26 in which the transmitter 14 is disposed and from which the transmitter 14 receives power.

The lighting fixture 26 can be a fluorescent lighting fixture 26. The lighting fixture 26 can be an incandescent lighting fixture 26. The lighting fixture 26 can be an LED lighting fixture 26. The apparatus 80 can include a light source in electrical communication with the lighting fixture 26.

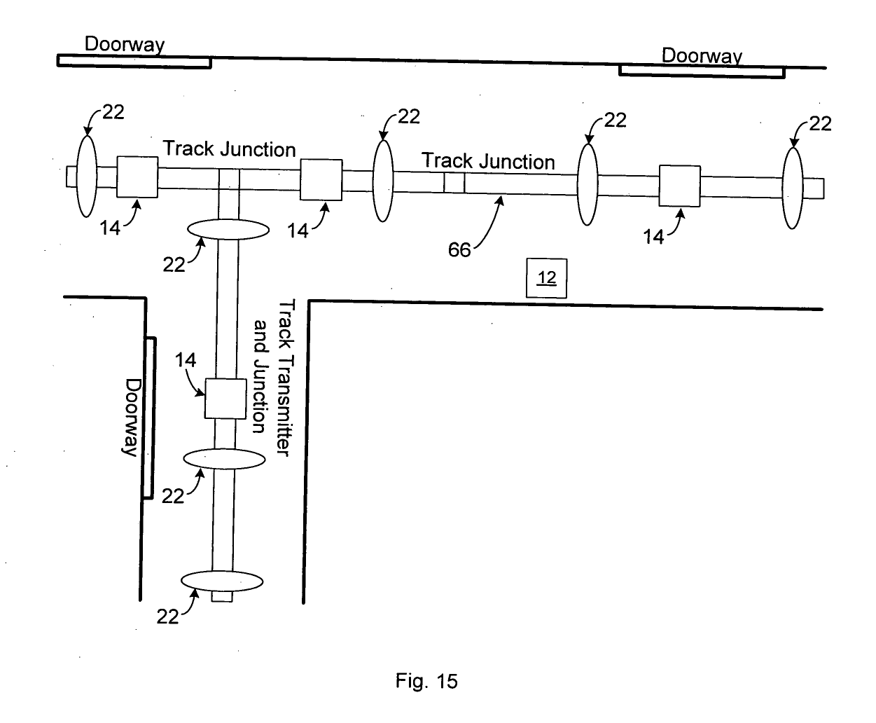

The present invention pertains to a power transmission system 10 for wirelessly powering a power harvesting device 12, as shown in FIG. 15. The system 10 comprises at least one RF power transmitter 14. The system 10 comprises a track 66 supplying power to which the transmitter 14 is electrically connected.

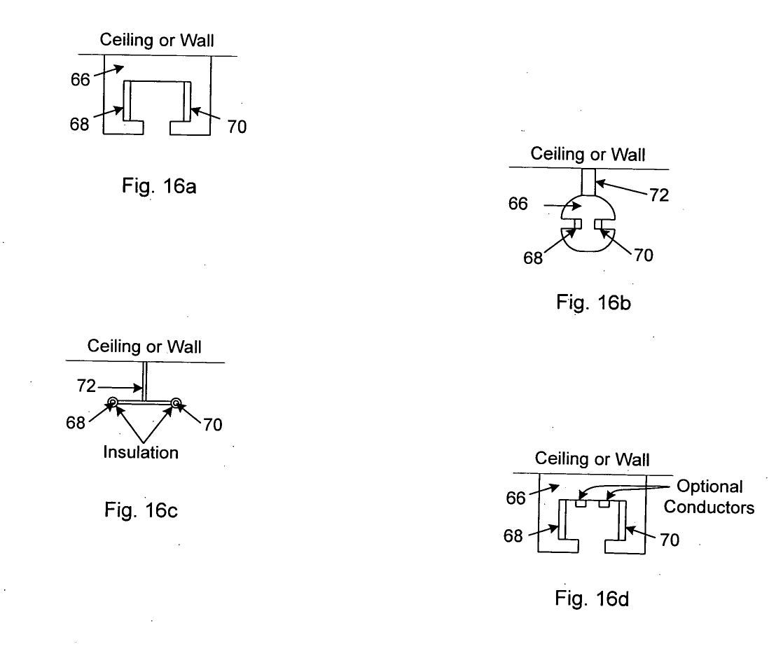

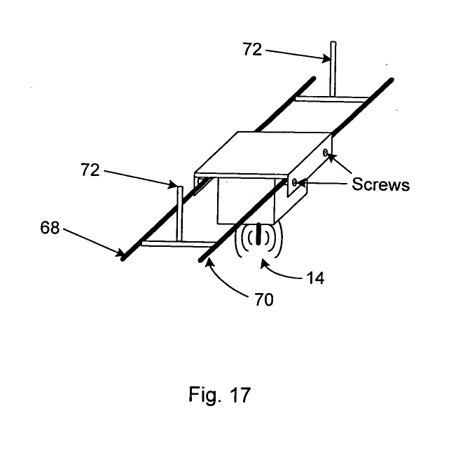

Preferably, there are at least two power transmitters 14. The system 10 can include at least two lights 22 electrically connected to the track 66. The track 66 can include a first conductor 68 and a second conductor 70, as shown in FIGS. 16a-16d. The track 66 may include a support 72 attached to a wall or ceiling, as shown in FIG. 17.

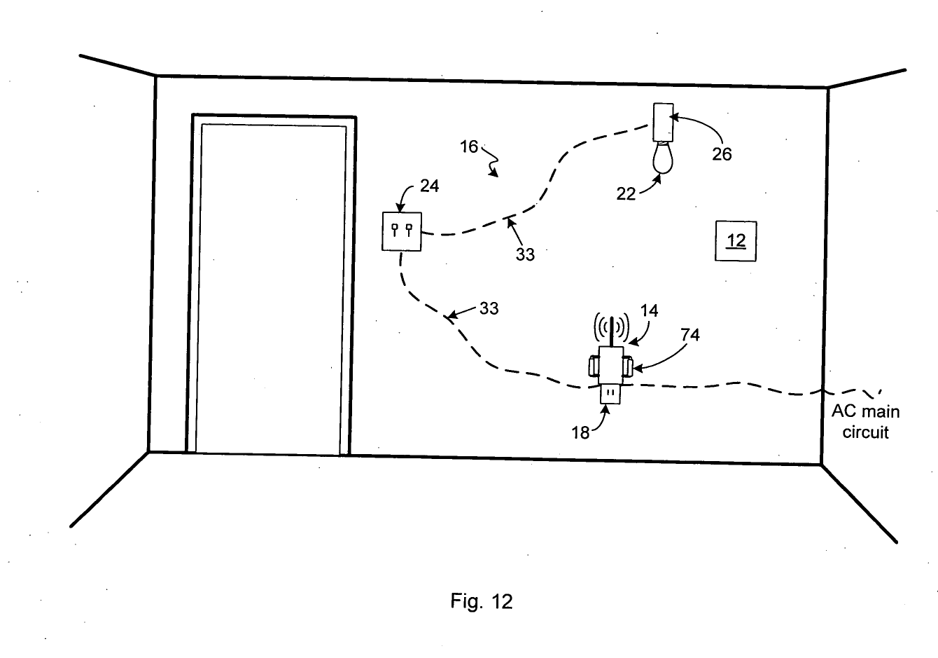

The present invention pertains to a power transmission system 10 for wirelessly powering a power harvesting device 12, as shown in FIG. 12. The system 10 comprises at least one RF power transmitter 14. The system 10 comprises a battery 74 charging unit to which the transmitter 14 is electrically connected.

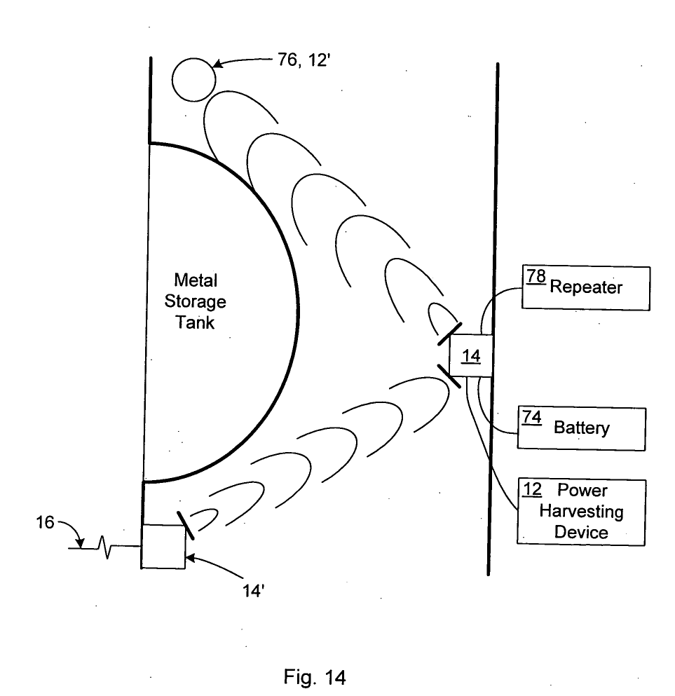

The present invention pertains to a power transmission system 10 for wirelessly powering a power harvesting device 12, as shown in FIG. 14. The system 10 comprises at least one RF power transmitter 14. The system 10 comprises at least one rechargeable battery 74 to which the transmitter 14 is electrically connected.

The system 10 can include a second RF power transmitter 14′ which transmits power to the power harvesting device 12 electronically connected to the battery 74. A valve sensor 76 can include the valve sensor 76′ powered by a power harvesting device 12′. The system 10 can include an RF power repeater 78.

The present invention pertains to a method for wirelessly powering a power harvesting device 12. The method comprises the steps of electrically connecting at least one RF power transmitter 14 to an AC power grid 16. There is the step of transmitting power with the RF power transmitter 14.

The present invention pertains to a method for wirelessly powering a power harvesting device 12. The method comprises the steps of electrically connecting at least one RF power transmitter 14 to a DC power grid 30. There is the step of transmitting power with the RF power transmitter 14.

The present invention pertains to a method for wirelessly powering a power harvesting device 12. The method comprises the steps of electrically connecting a power supply 60 with an RF transmitter 14 and a computer 58. There is the step of transmitting power with the RF power transmitter 14.

The present invention pertains to a method for wirelessly powering a power harvesting device 12. The method comprises the steps of electrically connecting at least one RF power transmitter 14 with a lighting fixture 26 in which the transmitter 14 is disposed and from which the transmitter 14 receives power. There is the step of transmitting power with the RF power transmitter 14.

The present invention pertains to a method for wirelessly powering a power harvesting device 12. The method comprises the steps of electrically connecting at least one RF power transmitter 14 to a battery 74 charging unit. There is the step of transmitting power with the RF power transmitter 14.

The present invention pertains to a power transmission system 10 for wirelessly powering a power harvesting device 12. The system 10 comprises at least one RF power transmitter 14. The system 10 comprises means for providing power to which the transmitter 14 is electrically connected.

The means can be an AC power grid 16, a DC power grid 30, a battery 74 or any other power sources identified herein.

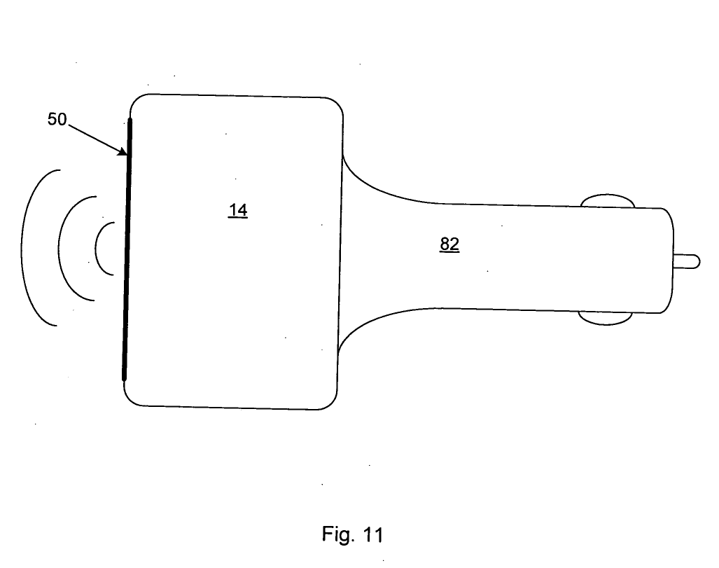

The present invention pertains to an apparatus 80 for wirelessly powering a power harvesting device 12 from a DC power outlet 18 of a vehicle 36, as shown in FIG. 11. The apparatus 80 comprises an RF power transmitter 14. The apparatus 80 comprises a power plug 82 to which the transmitter 14 is attached and electrically connected that plugs into the DC power outlet 18.

The present invention pertains to an apparatus 80 for wirelessly powering a power harvesting device 12 from an AC power grid 16 having an AC power outlet 18, as shown in FIG. 1. The apparatus 80 comprises an RF power transmitter 14. The apparatus 80 comprises a power plug to which the transmitter 14 is electrically connected that electrically connects with the AC power outlet 18.

The present invention pertains to an apparatus 80 for wirelessly powering a power harvesting device 12 from a DC power outlet 18 of a DC grid 30, as shown in FIG. 2. The apparatus 80 comprises an RF power transmitter 14. The apparatus 80 comprises a power plug to which the transmitter 14 is electrically connected that electrically connects with the DC power outlet 18.

The present invention pertains to an apparatus 80 for wirelessly powering a power harvesting device 12 from a computer 58 having an antenna 50 and a power supply, as shown in FIG. 13. The apparatus 80 comprises an RF power transmitter 14. The apparatus 80 comprises a power plug to which the transmitter 14 is electrically connected that electrically connects with the computer 58.

The present invention pertains to an apparatus 80 for wirelessly powering a power harvesting device 12 from a light fixture 26, as shown in FIG. 5. The apparatus 80 comprises an RF power transmitter 14. The apparatus 80 comprises an electrical interface to which the transmitter 14 is electrically connected that electrically connects with the light fixture 26.

The present invention pertains to an apparatus 80 for wirelessly powering a power harvesting device 12 from a track 66 having at least one light 22, as shown in FIG. 15. The apparatus 80 comprises an RF power transmitter 14. The apparatus 80 comprises an electrical interface to which the transmitter 14 is electrically connected that electrically connects with the track 66.

The present invention pertains to an apparatus 80 for wirelessly powering a power harvesting device 12 from a battery 74 charging unit, as shown in FIG. 14. The apparatus 80 comprises an RF power transmitter 14. The apparatus 80 comprises an electrical interface to which the transmitter 14 is electrically connected that electrically connects with the battery 74 charging unit.

The design of a Radio-Frequency (RF) Power Transmitter and an RF Power Network have been described in detail in U.S. patent application Ser. No. 11/356,892, “Pulse Transmission Method”, U.S. continuation-in-part patent application Ser. No. 11/651,818, “Pulse Transmission Method”, U.S. provisional application Ser. No. 11/438,508, “Power Transmission Network”, and U.S. provisional continuation-in-part application 60/833,864, “Power Transmission Network and Method”, all incorporated by reference herein. The referenced patents give great detail on how an RF Power Transmitter and an RF Power Network can be constructed for various transmitter and antenna 50 combinations. It, however, also becomes advantageous, and the focus of the invention, to describe how the RF Power Transmitters 14 and RF Power Network derive the power used for operating the components necessary to both such as, but not limited to, transmitter(s) 14, controller(s) 48, and/or antenna(s) 50. It should be noted that an RF Power Network is made up of more than one RF power transmitter 14 where the coverage areas 38 may or may not overlap and the RF power transmitter 14 includes one or more antenna 50 for transmitting the generated RF power which may be pulsed or continuous. It should also be noted that RF power transmitters 14 and RF power networks may be used to directly power one or more RF harvesting devices or charge, recharge, or trickle charge a power storage component. An RF power receiver such as, but not limited to, the RF power receivers described in U.S. provisional application 11/584,983, “Method and Apparatus for High Efficiency Rectification for Various Loads”, may be used with the presented invention although any RF harvesting device may be used. It should be noted that a device containing RF harvesting circuitry may be referred to herein as an RF harvesting device, an RF power harvesting device 12, or an RF power receiver. Additionally, the apparatus 80, with or without the receiving antenna 50, for converting the RF energy to a usable form such as, but not limited to, direct current (DC), may be referred to herein as the RF harvesting circuitry, RF power harvester, or RF power receiver.

It should be noted that the RF power transmitters 14 and RF power network in the invention should not be confused with RF power transmitters 14 using inductive coupling, which requires the device to be relatively close to the power transmission source. The RFID Handbook by the author Klaus Finkenzeller defines the inductive coupling region as distance between the transmitter 14 and receiver of less than 0.16 times lambda where lambda is the wavelength of the RF wave. The proposed invention can obtain power in the near field (sometimes referred to as inductive) region as well as the far-field region. The far-field region is distances greater than 0.16 times lambda.

One method for obtaining power for an RF power transmitter 14 and/or RF power network would be to hardwire the RF power transmitter 14 or RF power network to an Alternating Current (AC) power grid or source used to supply power to lights, outlets, and other devices with voltages from 100 to 240 volts. This may be the ideal choice for new construction projects where the wiring can be easily accessed and the RF power transmitters 14 can be installed along with the wiring, lighting fixtures 26, switches, and outlets. The RF power transmitter 14 and/or RF power network may then contain an AC to DC converter 28 that can convert the AC power obtained from the AC power main or source to a usable DC voltage (or current) such as but not limited to 3.3 to 48 volts. An example of this transmitter 14 and network implementation is shown in FIG. 1. It should be noted that the RF power transmitter(s) 14 and/or RF power network may be hardwired to a DC network or source, if available, and, if needed, the RF power transmitter(s) 14 and/or RF power network may use a DC to DC converter to obtain the correct operational voltage. An example of a DC network or source includes, but is not limited to, the wiring within an automobile, car, truck, van, recreational vehicle, bus, public transportation, commercial truck, commercial equipment, construction equipment, industrial equipment, farm equipment, airplane, boat, ship, submarine, computer 58, or any other manned or unmanned apparatus 80 containing a DC network or source. As an example, an RF power transmitter 14 may be hardwired to the 12 volt DC network or source within an automobile. At least one RF power transmitter 14 may be installed in the engine compartment, dash, ceiling, cabin, or trunk of the automobile to provide RF power to RF power harvesting devices 12 inside or outside (if within the coverage area 38) of the automobile. The RF power harvesting devices 12 may include, but are not limited to, cellular phones, cellular phone accessories, car phones, voice communicating devices, PDAs, music players, laptops, toys, car sensors, or other devices that may require power.

As an example, an RF power transmitter 14 may be mounted on a utility pole 32 and hardwired to the AC power grid 16 in order to provide RF power to RF energy harvesting devices within the coverage area 38. Multiple RF power transmitters 14 may be implemented in order to provide an RF power network.

As a specific example, at least one RF power transmitter 14 may be implemented by direct hardwiring to the DC network in the dashboard of an automobile in order to charge a cellular phone containing RF power harvesting circuitry while the cellular phone is inside the automobile or outside the automobile but still within the coverage area 38 of the RF power transmitter 14. The coverage area 38 for the automobile in this example would be designed to give coverage over the cabin of the automobile as shown in FIG. 2. For most automobiles, the coverage area 38 would have a range of 6 to 8 feet from the RF power transmitter 14. The coverage area 38 is defined by a minimum electric and/or magnetic field strength produced by the RF power transmitter 14. The range of the RF power transmitter 14 or coverage area 38 is defined as the distance from the RF power transmitter 14 to the outer limit of the coverage area 38 for a specific angle with respect to the RF power transmitter 14. The coverage area 38 may take on different shapes and sizes and is dependent on numerous factors including, but not limited to, the RF power transmitter 14 power level, the gain and radiation pattern of the RF power transmitting antenna 50, the environment, and the power needs of the RF power harvesting devices 12 in the coverage area 38. For an automobile, it may be necessary to provide 1 milli-watt (mW) of power to an RF power harvesting device 12 within the cabin having a maximum range of six feet. If omnidirectional antennas 50 are used by the RF power transmitter 14 and the RF harvesting circuit at 915 mega-Hertz (MHz), the RF power transmitter 14 would need to supply 2 Watts (W) of power to the RF power transmitting antenna 50 in order to supply the needed power to the RF power harvesting device 12 at a range of six feet. An RF power transmitter 14 has been designed and constructed to meet these requirements. The adjustable RF power transmitter 14 is capable of transmitting 0.25 W to 20 W of power as a continuous-wave (CW) or as a pulsed-wave (PW). The transmitter 14 has outside dimensions of 1.5×1.5×4.775 inches as shown in FIG. 3. The omnidirectional antennas 50 at 915 MHz may be implemented with half-wave dipoles that have a length of 6 inches and a diameter of 0.1 inches.

It should be noted that the RF power transmitter 14 shown in FIG. 3 may be used with any of the embodiments herein if found to be advantageous. The RF power transmitter 14 may contain a power input 42 for accepting AC or DC power, a frequency generator 44 for generating the appropriate frequency(ies), an amplifier 46 and/or preamplifier for adjusting the output power (gain or attenuation), a controller 48 for controlling the amplifier 46 and frequency generator 44, a heat sink 54 for dissipating heat from or cooling the RF power transmitter 14, a fan 56 for providing air flow through or across the heat sink 54 and/or printed circuit board 52 for cooling, a printed circuit board 52 (PCB) for component mounting, and an RF output connection for supplying the RF power to the RF power transmitting antenna 50. The RF power transmitting antenna 50 may also be integrated onto the PCB.

It should be noted that one or more antennas 50 may be used with the invention and the antennas 50 may have omnidirectional or directional radiation patterns and may be designed to have linear, circular, elliptical, dual, or any other type of polarization that may be advantageous to the RF power system 10.

For the case of a DC network or source with a computer 58, an RF power transmitter 14 may be hardwired to the 12-volt power supply 60 in order to supply RF power to devices located in or around the computer 58. The computer 58 may have one or more antennas 50 located internally or externally in communication with the RF power transmitter 14. As an example, the RF power transmitter 14 may be located in the computer 58 case while the antennas 50 are mounted in or on the monitor or display. The monitor may have two antennas 50, one on each side of the screen in order to give a better coverage area 38 or network. The antennas 50 may be connected to the computer 58 case using one or two coaxial cables or the RF power may be supplied through a conductor in the monitor cable. As a specific example, the RF power transmitter 14 may have dimensions of 5.75 by 6.69 by 1.63 inches allowing the RF power transmitter 14 to fix into a bay within the computer 58 tower typically used for CD-ROM and DVD drives. The RF power transmitter 14 may accept a plug 82 from the computer 58 power supply 60. The RF power transmitting antenna 50 may be external to the computer 58 tower or may be formed on the front of the RF power transmitter 14. Additionally, the RF power transmitter 14 may be in communication internally with the computer 58 or part of the computer 58 for control of the RF power transmitter 14 or for controlling communication with RF power harvesting devices 12 receiving RF power from the RF power transmitter 14. The RF power transmitter 14 may also be formed as a card designed to plug into standard computer 58 or laptop slots such as, but not limited to, PCI bus slots, AGP slots, PCI express slots, ISA slots, PCMCIA slots, or any other computer 58 or laptop slot. In certain applications, the RF power transmitter 14 may also be formed on the motherboard of the computer 58 with the RF power antenna 50 being internal or external to the computer 58 tower.

Additionally, the RF power transmitters 14 may be recessed or flush mounted like an AC or DC outlet 18 or switch, or may replace, or be used in conjunction, with an AC or DC outlet 18 whether existing or specialized to include an RF power transmitter 14 and RF power antenna 50. An example of this can be seen in FIG. 4 where the AC outlet 18 from FIG. 1 has been replaced with the RF power transmitter 14. The RF power transmitter 14 is mounted flush with the wall. In this example, the box retains the function of providing AC power to devices that plug into it, but also transmits RF power through an RF power antenna 50 that is mounted behind the wall. Furthermore, the RF power transmitter 14 may fit completely into a standard junction box 34 with the RF power antenna 50 being internal or the antenna 50 may be connected outside the junction box 34 by a connector exiting through the junction box 34 or junction box 34 cover. The RF power transmitter 14 may have dimensions of 3.8 by 3.8 by 2.1 inches in order to fit in a junction box 34, and the RF power transmitting antenna 50 may have a length of 6 inches and a diameter of 0.1 inches for a 915 MHz RF power transmitter 14. In certain instances the cover of the junction box 34 could be or contain the RF power antenna 50. It may also be possible to embed the RF power transmitter 14 and/or RF power antenna 50 on or in, partially or completely, the material of the structure that the RF power transmitter 14 and/or RF power antenna 50 are mounted to, in, or behind, depending on the attenuating properties of the material. The RF power transmitter 14 and/or RF power antenna 50 may also be located behind the material to eliminate the need for an opening in the material for the RF power transmitter 14 and/or RF power antenna 50 to protrude through. As an example, the RF power transmitter 14 and RF power antenna 50 may be implemented by direct connection to the AC power main or source and be completely located behind a low attenuation wall at the frequency of the RF power transmitter 14.

In cases of an existing structure or an implementation requiring a simpler installation, it may be advantageous to develop additional methods for deriving the power for the RF Power Transmitter 14 and/or RF Power Network. As an example, in an existing building it may be necessary to access wiring inside the walls or ceiling in order to hardwire the RF power transmitter(s) 14 to the AC power main which may require that an opening be made and repaired. The destruction and construction required for the opening in the wall may require building permits and trained or experienced personal such as an electrician, carpenter, or other contractor. This process may not be an attractive solution for certain implementations. Therefore, it becomes necessary to develop additional methods other than direct hardwiring of the RF power transmitter(s) 14. One such method is to design a transmitter 14 that can be used in conjunction with an existing lighting fixture 26, lamp, or other power receptacle for a light source. A light source may include, but is not limited to, a light bulb, an incandescent light, a fluorescent bulb, a fluorescent lamp, a halogen bulb, a light-emitting diode (LED), an organic light-emitting diode (OLED), a full spectrum bulb, or any other light producing device. As an example, a transmitter 14 could be constructed in a fashion that would enable it to screw or plug into an existing lighting fixture 26, lamp, or other power receptacle for a light 22 source using a standard or custom base, such as but not limited to, Candelabra/E12, Intermediate/E17, Medium/E26, Mogul/E39, Bayonet, (T8) Medium Bi-Pin, (T12) Medium Bi-Pin, (T5) Miniature Bi-Pin, or any other type of connector used to connect the light 22 source to the AC or DC power main. The resulting transmitter 14 would replace the light 22 source to provide coverage of RF power rather than light 22 where the RF energy could be used to deliver power to devices containing RF power harvesting circuitry. An example of this invention can be seen in FIG. 5. In this example, the RF power transmitter 14, like the light 22 source it is replacing, protrudes from the lighting fixture 26, but in some cases the, the RF power transmitter 14 may be recessed into the fixture. The RF power transmitter 14 may have dimensions of 1.6 by 1.6 by 4 inches in order to fit in a lighting fixture 26, and the RF power transmitting antenna 50 may have a length of 6 inches and a diameter of 0.1 inches for a 915 MHz RF power transmitter 14.

When implementing an RF power transmitter 14 solely or within an RF power network, it may not always be practical to completely remove the light 22 source from the lighting fixture 26, lamp, or other power receptacle for a light 22 source. In this case, the transmitter 14 could, as previously described, screw or plug into the existing lighting fixture 26, lamp, or other power receptacle for a light 22 source and also include the ability to accept a light 22 source with a standard or custom base, such as but not limited to, Candelabra/E12, Intermediate/E17, Medium/E26, Mogul/E39, Bayonet, (T8) Medium Bi-Pin, (T12) Medium Bi-Pin, (T5) Miniature Bi-Pin, or any other type of connector used to connect the light 22 source to the AC or DC power main. The ability to accept a light 22 source allows the lighting fixture 26, lamp, or other power receptacle for a light 22 source to contain an RF power transmitter 14 and a light 22 source meaning the lighting fixture 26, lamp, or other power receptacle for a light 22 source can perform its primary function of supplying light 22 while also performing a secondary function of providing RF power to devices containing RF power harvesting circuitry. An example of this method can be seen in FIG. 6. It should be noted that the type of base in the lighting fixture 26, lamp, or other power receptacle for a light 22 source may be different than the type of base in the RF power transmitter 14 that accepts the light 22 source. More specifically, the lighting fixture 26, lamp, or other power receptacle for a light 22 source may have a Mogul/E39 base while the RF power transmitter 14 accepts a light 22 source with a Medium/E26 base. Additionally, the lighting fixture 26, lamp, or other power receptacle for a light 22 source may be recessed into the ceiling, wall, or mounting surface. The RF power transmitter 14 may have dimensions of 4 by 4 by 1 inch in order to fit into a recessed lighting fixture 26 that accepts a light bulb, and the RF power transmitting antenna 50 may have a length of 6 inches and a diameter of 0.1 inches for a 915 MHz RF power transmitter 14.

To simplify the previous example, the light 22 source could be integrated into the RF power transmitter 14 to allow the light 22 source and RF power transmitter 14 to work in conjunction with one another as shown in FIG. 7. As an example, the antenna 50 of the RF power transmitter 14 could be formed from part of metal contained within the existing light 22 source or the antenna 50 could be integrated into or onto the light 22 source as a custom solution. The antenna 50 may be formed by depositing metal or any other conductive material on the glass of the light 22 source to form a resonant antenna 50 structure. The conductive material may have transparent or semi-transparent properties to allow light 22 to pass through the antenna 50 structure. A transparent antenna 50 may be formed using a material such as, but not limited to, Indium Tin Oxide. The antenna 50 may also be formed inside the light 22 source if found to be advantageous. In cases where a directional light 22 source is used to focus the light 22 to a specific area using a light 22 reflective surface, the antenna 50 could use the reflective surface, if metallic, to also reflect or focus the RF energy transmitted from the antenna 50. It may become necessary to use a long-life light 22 source such as an LED to reduce the amount of maintenance on each lighting fixture 26, lamp, or other power receptacle for a light 22 source. When the light 22 source or RF power transmitter 14 cease normal operation, the RF power transmitter 14 and light 22 source combination can be easily replaced by unscrewing or unplugging the RF power transmitter 14 with integrated light 22 source. The used device may be repaired or simply discarded depending on the application. It should be noted that the RF power transmitter 14 and light 22 source combination may be recessed into the lighting fixture 26. The RF power transmitter 14 with integrated light 22 source may have dimensions of 4 by 4 by 6 inches in order to fit into a recessed lighting fixture 26, and the RF power transmitting antenna 50 may have a length of 6 inches and a diameter of 0.1 inches for a 915 MHz RF power transmitter 14.

In the two previous implementations, the RF power transmitter 14 accepted or had a built-in light 22 source. In certain applications, the RF power transmitter 14 may be integrated into an existing or specialized lighting fixture 26. As an example, typical lighting in an office building is provided by lighting fixtures 26 containing four four-foot fluorescent lights. This type of lighting fixture 26 may be retrofitted with at least one RF power transmitter 14 or the lighting fixture 26 may be redesigned to contain at least one RF power transmitter 14. An example of this can be seen in FIG. 8. As an additional example, an RF power transmitter 14 may be used in conjunction with an existing or specialized light bulb and/or fixture within a street light for the purpose of providing power to RF power harvesting devices 12 within the coverage area 38 defined by one or more street lights. Additionally, an RF power transmitter 14 may be implemented with landscape, exterior, emergency, specialty, automobile, or any other type of lighting fixture 26 or light 22 producing source. For the case of the automobile, an RF power transmitter 14 may be implemented with or within the interior lights or headlights to provide RF power to devices within the resulting coverage area 38.

Another way of implementing an RF power transmitter 14 and/or RF power network is to connect the transmitter(s) 14 to existing outlets 18, receptacles, ports, or connectors within a building, automobile, device or structure by a plug 82 and cord 20 that can be used to provide AC or DC directly from the outlet 18. In most cases for an AC power grid 16 or source, the DC power may be obtained from an AC to DC converter 28 located at the outlet 18, receptacle, port 64, connector or somewhere between the outlet 18, receptacle, port 64, or connector and RF power transmitter 14. As an example, an RF power transmitter 14 and/or RF power network may be designed to give coverage over a desk, a room, an entire home, an entire building floor, the entire building, or an automobile. The coverage area 38 is defined by a minimum electric and/or magnetic field strength produced by the RF power transmitter 14. As in the case of the desk or room, a single RF power transmitter 14 may be sufficient to give coverage over the required area. Therefore, the RF power transmitter 14 may be designed to plug into an existing outlet 18 near the desk or somewhere within the room. The ability to have a cord 20 gives flexibility to the RF power network design by allowing the use of an existing AC or DC outlet 18 with the ability to place the RF power transmitter 14 away from the AC or DC outlet 18. As an example, it may be necessary to provide RF power coverage over a bedroom in order to recharge a medical implant within a patient while they are located within their bedroom. The RF power transmitter 14 can then be located on the nightstand or can be attached to the headboard in order to supply RF power to the medical implant to recharge the implant's battery 74 or power storage component. The RF power transmitter 14 can obtain its operational power by plugging into one of the AC outlets 18 in the room where the AC outlet 18 may be located several feet from the RF power transmitter 14 location as shown in FIG. 9. Several RF power transmitters 14 have been designed at 915 MHz that plug into an existing AC outlet 18 using a power cord 20. The first RF power transmitter 14 had dimensions of 2.6 by 4.25 by 1.26 inches and an output power of 0.5 W while the second had dimensions of 4.4 by 6.4 by 2 inches and an output power of 5 W. The RF power transmitting antenna 50 for the first transmitter 14 was a monopole with a length of 3 inches while the second RF power transmitting antenna 50 was a dipole and had a length of 6 inches and a diameter of 0.1 inches.

For the case of an automobile, the RF power transmitter 14 may plug into the 12V DC power outlet 18 or cigarette lighter outlet 18 through a cord 20 and the RF power transmitter 14 may then be placed on the dash or the center console in order to provide RF power to devices containing RF power harvesting circuitry in the coverage area 38 provided by the RF power transmitter 14 and RF power antenna 50.

For the case of a computer 58, the RF power transmitter 14 may plug into existing or specialized computer 58 ports 64, such as, but not limited to, USB, serial, parallel, FireWire, or any other power carrying port 64, through a cord 20 in order to supply power to an RF power transmitter 14.

It should be noted that an RF power transmitter 14 may plug into other devices, directly or with a cord 20, such as, but not limited to, a console gaming system, computer 58, laptop computer 58, or any other device have an outlet 18, receptacle, port 64, or connector that may be used to obtain power for an RF power transmitter 14.

It should also be noted that any of the RF power transmitters 14 described herein may have the ability to supply power to other devices by having an outlet. 18, receptacle, port 64, or connector that may be the same or a different type than the one supplying the RF power transmitter 14. As an example, an RF power transmitter 14 being powered from a USB or Ethernet port 64 may have a USB or Ethernet port 64 to allow other devices to use the same USB or Ethernet port 64 as the RF power transmitter 14.

In certain applications, it may not be necessary to run a cord 20 from the outlet 18, receptacle, port 64, or connector to the RF power transmitter 14. The AC or DC outlet 18, receptacle, port 64, or connector may be positioned in a location that provides the required RF energy coverage when the RF power transmitter 14 is located at the location of the outlet 18, receptacle, port 64, or connector. In these cases, the RF power transmitter 14 can simply plug into the outlet 18, receptacle, port 64, or connector without the need for an extension cord 20. The RF power transmitter 14 may be supported in whole or part by the friction created from the AC or DC prongs inserted into the outlet 18, receptacle, port 64, or connector. Additionally, the RF power transmitter 14 may pass the AC or DC power to at least one AC or DC outlet 18, receptacle, port 64, or connector located on the RF power transmitter 14 in order to enable other devices to plug into the AC or DC main or source through the RF power transmitter 14. The RF power transmitter 14 may have one or more antenna 50 that are used to radiate and/or direct the RF power away from the outlet 18, receptacle, port 64, or connector to an RF power receiving device containing RF power harvesting circuitry which can harvest the available RF power to power a device or charge or recharge a charge storage component such as a battery 74, capacitor, or other charge storage component. FIG. 10 shows an example of an RF power transmitter 14 that plugs directly into an AC outlet 18. An RF power transmitter 14 plugging directly into an AC outlet 18 may have dimensions of 2.6 by 4.25 by 1.26 inches, and the RF power transmitting antenna 50 may have a length of 6 inches and a diameter of 0.1 inches for a 915 MHz RF power transmitter 14.

For the case of an automobile, the RF power transmitter 14 may plug directly into the 12V DC power outlet 18 or cigarette lighter outlet 18 without the need for a cord 20 in order to provide RF power to devices containing RF power harvesting circuitry in the coverage area 38 provided by the RF power transmitter 14 and RF power antenna 50. An example of an RF power transmitter 14 that plugs directly into the DC power outlet 18 of an automobile can be seen in FIG. 11. An RF power transmitter 14 plugging directly into a DC outlet 18 may have dimensions of 2 by 2 by 1 inch, and the RF power transmitting antenna 50 may be internal or external to the RF power transmitter 14 and have a length of 6 inches and a diameter of 0.1 inches for a 915 MHz RF power transmitter 14.

For the case of a computer 58, the RF power transmitter 14 may plug directly into existing or specialized computer 58 ports 64, such as, but not limited to, USB, serial, parallel, FireWire, or any other power carrying port 64, in order to supply power to an RF power transmitter 14.

It may be beneficial in certain applications to include a battery 74 charger or power storage component charger with the RF power transmitter 14. This solution is of particular interest when the RF power harvesting device 12 may require more power than the RF power transmitter 14 or RF power network can provide or if the RF power harvesting device 12 needs to obtain a fast charge such as when the battery 74 voltage level has fallen below the minimum threshold for operation of the device. The battery 74 or other charge storage component that is normally charged or recharged from the RF power transmitted by the RF power transmitters 14 and/or RF power network could be removed from the device and placed in the battery 74 or charge storage component recharger built-in to the RF power transmitter 14 for a faster charging where the recharger is powered directly by the AC or DC power main. A battery 74 or charge storage component charger could be included in any of the implementations described in this document. An example of including a battery 74 charger with an RF power transmitter 14 is shown in FIG. 12 for the case of the RF power transmitter 14 that directly plugs into an AC outlet 18. An RF power transmitter 14 with a battery 74 charger plugged directly into an AC outlet 18 may have dimensions of 2.6 by 4.25 by 1.26 inches, and the RF power transmitting antenna 50 may have a length of 6 inches and a diameter of 0.1 inches for a 915 MHz RF power transmitter 14.

For the case of an automobile, the RF power transmitter 14 may plug directly into the 12V DC outlet 18 or may have a cord 20 and the RF power transmitter 14 may then be placed on the dash or the center console in order to provide RF power to devices containing RF power harvesting circuitry in the coverage area 38 provided by the RF power transmitter 14 and RF power antenna 50. Additionally, the RF power transmitter 14 may contain a battery 74 charger or charge storage component charger in order to obtain a faster charge cycle. The charger may be designed to accept standard battery 74 sizes such as AA, AAA, C, and/or D cell batteries or may be designed to accept a product specific battery 74 that may or may not be attached to the device at the time of charging. As an example, a cellular phone may contain RF power harvesting circuitry for capturing RF power when within the coverage area 38 provided by the RF power transmitter 14. The RF power transmitter 14 may also contain a cradle with charging connections that would allow the cellular phone to be directly charged by a hardwired connection in order to obtain a faster charge.

In certain applications, the RF power transmitter 14 may obtain operational power from a battery 74 or charge storage component in order to transmit RF power. The battery 74 or charge storage component may include, but is not limited to, rechargeable batteries, capacitors, fuel cells, generators, other charge storage components, or other charge generating components. In some cases, the RF power transmitter 14 may draw its power from a battery 74 or charge storage device that is supplying power to other devices simultaneously. For example, a laptop computer 58 uses a battery 74 for operational power. An RF power transmitter 14 could be attached with or without a cord 20 to the laptop computer 58, by means disclosed herein such as through the USB port 64 of the laptop computer 58, and would use the same battery 74 for operational power that the laptop computer 58 is using. An example of the RF power transmitter 14 directly connected to a computer 58 is shown in FIG. 13. The RF power transmitter 14 could then supply power to computer 58 peripherals or other devices within its coverage area 38, such as, but not limited to, keyboards, mice, game controllers, cellular phones, cellular phone accessories, PDAs or other peripherals or devices that are designed with RF power harvesting circuitry. An RF power transmitter 14 plugging directly into the USB or other port 64 of a computer 58 may have dimensions of 3 by 0.75 by 0.75 inches, and the RF power transmitting antenna 50 may be integrated with the RF power transmitter 14.

In certain applications, the battery 74 or charge storage component used to run the first RF power transmitter 14 may be receiving power from a second RF power transmitter 14 for the purpose of charging the battery 74 or charge storage element in the first RF power transmitter 14. Power for the second RF power transmitter 14 may be obtained from an AC or DC power network or by other means described herein. As an example, it may be necessary to supply power to an RF power-harvesting device, which is located in a position that does not allow direct line-of-sight or a low attenuation transmission path. As a specific example, an RF power transmitter 14 may be required to supply power to a valve sensor 76 in an industrial application. However, the AC power grid 16 used for obtaining operational power for the RF power transmitter 14 may be located on one side of a large metal storage tank while the valve sensor 76 requiring power may be located on the opposite side. In order to obtain sufficient power at the valve sensor 76, an additional RF powered RF power transmitter 14 may be required in order to direct, relay, or bounce the power around the metal storage tank as shown in FIG. 14. The RF powered RF power transmitter 14 may be an RF power transmitter 14 also containing an RF power harvesting device 12 or may be implemented with a passive RF repeater 78. The passive RF repeater 78 receives the power with one antenna 50 and passes the RF power to a second antenna 50, which retransmits the power in a different direction.

When deploying multiple RF power transmitters 14 in an RF power network, it becomes necessary to develop a method that allows the installer or user to easily and quickly install or add RF power transmitters 14 to the RF power network. One solution is to build an RF power transmitter 14 that can be installed into the track 66 of existing track 66 lighting. The RF power transmitters 14 can then be easily retrofitted into existing structures or places containing track 66 lighting. The RF power transmitter 14 can simply snap or screw into the track 66 to obtain AC or DC power depending on the type of track 66 lighting. The power track 66 could then contain both lights 22 and RF power transmitters 14 although the track 66 may contain only RF power transmitters 14. It should be noted that the track 66 may contain RF power transmitters 14 that accept or have built-in light 22 sources as previously described herein.

It is also possible to develop a specialized type of track 66 that allows the tracks 66 to be concatenated with track 66 junctions to incorporate a large number of RF power transmitters 14 in order to cover a large area. The tracks 66 may be, but are not limited to, six feet in length. The track 66 junctions may contain, but are not limited to, a connector (whether a plug 82, snap, or clip) or a slip-in fitting in order to concatenate tracks 66 to obtain longer lengths. It is also possible to design a track 66 junction that could be used to connect two or more tracks 66 together by connectors or slip-in fittings in order to change the direction of the track(s) 66 or to connect multiple tracks 66. Additionally, it is possible to design an RF power transmitter 14 that can be used as an RF power transmitter 14 and a track 66 junction. An example of a track 66 system for implementation of an RF power network can be seen in FIG. 15. It should be noted that the track 66 may contain light 22 sources.

Each track 66 may contain at least two conducting portions in order to provide an input and return for the AC or DC power for the RF power transmitters 14. As an example for an AC main implementation, the input line is the AC hot wire, typically the black wire, and the return line is the AC neutral wire, typically the white wire. The track 66 and supporting structure, if metal, may be connected to the AC ground for safety purposes. There may also be a ground wire and a wire used for communicating between the RF power transmitters 14 in order for an RF power transmitter 14 to obtain information about other RF power transmitters 14 operations such as, but not limited to, pulse timing, polarization, frequency, power level, transmission algorithm, antenna 50 gain, or other pertinent information. The communication between the RF power transmitters 14 may be done by, but not limited to, a microcontroller integrated in the RF power transmitter 14 with each having a unique identification or a master/slave configuration. It should be noted that for large implementations of RF power transmitters 14, it may become necessary to split the communicating portion of the network into multiple smaller networks which could be accomplished with, but not limited to, a special track 66 junction that only passes the AC or DC power and isolates the communication conductors.

The tracks 66 used for the invention can take many different forms. The proposed invention can be implemented with any type including, but not limited to, snap-in tracks 66, screw-in tracks 66, sliding tracks 66, concatenatable tracks 66, AC tracks 66, DC tracks 66, or any other track 66 that can supply current to at least one RF power transmitter 14. It should be noted that the track 66 may take on various shapes including, but not limited to, those shown in FIG. 16.

One track 66 that is particularly advantageous is the coated cable shown in FIG. 16c. One cable is the input path while the other cable acts as the return path. The cable could be used to supply either AC or DC power to the RF power transmitter 14 although DC would have numerous advantages due to safety issues, fire concerns, and building regulations. The RF power transmitters 14 could be set on top of the cable, which would supply power and support the RF power transmitters 14. The RF power transmitters 14 could have at least one screw for each cable in order to secure the RF power transmitter 14 to the cable and to pierce the non-conducting protective coating on the outside of the conducting cable. An example of an RF power transmitter 14 connected to the cable track 66 system 10 can be seen in FIG. 17. It should be noted that additional cables could be used for, but not limited to, ground, communication, or some other signal if found to be advantageous. As with the network shown in FIG. 15, the cable track 66 system 10 could be used to provide coverage over a hallway or hallways. The main advantage of the cable track 66 system 10 is its easy installation. The cable may be a large spool of cable allowing long runs of track 66 without the need for track 66 junctions. It is also possible to implement curved tracks 66 using the cable track 66 system 10, which would allow the tracks 66 to turn corners or be installed in a circular fashion in a large room. Track 66 junctions may be used to connect multiple tracks 66 together as previously described. The supports 72 for the tracks 66 may simply snap or clamp to the cable to provide the proper spacing and support to the cable and RF power transmitters 14 and RF power antennas 50. The RF power cable track 66 system 10 may be implemented behind a material for aesthetic purposes such as, but not limited to, a wall, ceiling, or drop ceiling.

An RF power transmitter 14 has been designed and constructed to meet the requirements of the track 66 system 10. The adjustable RF power transmitter 14 is capable of transmitting 0.25 W to 20 W of power as a continuous-wave (CW) or as a pulsed-wave (PW). The transmitter 14 has outside dimensions of 1.5×1.5×4.775 inches. The RF power transmitting antenna 50 at 915 MHz may be implemented with a half-wave dipole that has a length of 6 inches and a diameter of 0.1 inches.

It should be noted that the RF power transmitters 14 described herein may contain communication circuitry and a communication antenna 50 in order to obtain operational information such as, but not limited to, timing, transmitted power, transmission algorithm, frequency, antenna 50 characteristics, or any other information from other RF power transmitters 14. Additionally, the RF power transmitters 14 may contain a power sensor and antenna 50 for measuring the amount of power transmitted by other RF power transmitters 14 in order to obtain information such as, but not limited to, timing, transmitted power, transmission algorithm, frequency, antenna 50 characteristics, or any other information from other RF power transmitters 14.

It should be noted that the RF power transmitters 14 described herein may be implemented as a single RF power transmitter 14 or as part of an RF power network where the coverage area 38 of each RF power transmitter 14 may or may not overlap.

Numerous examples have been given herein that describe the physical size of the RF power transmitter 14 and RF power transmitting antenna 50 which may be dependent on one or more of several factors including, but not limited to, transmitted RF power, RF power transmitting antenna 50 gain, the frequency(ies) of the RF power transmitter 14, the required RF power coverage area 38, heat sink 54 size, amount of air movement by the fan 56 or by the environment, ambient temperature, and the type of operational power available for the RF power transmitter 14. These factors may be adjusted or modified to obtain the desired physical size needed in order to implement the RF power transmitter 14 in a practical application such as, but not limited to, using an RF power transmitter 14 plugged directly into a computer 58 to supply RF power to an RF power harvesting device 12 that has been installed into a cellular phone, or using an RF power network to provide an RF power coverage area 38 that covers an office.

The coverage areas 38 and range of the RF transmitters 14 described herein may be dependent on one or more of numerous factors including, but not limited to, transmitted RF power, RF power transmitting antenna 50 gain, the frequency(ies) of the RF power transmitter 14, the type and amount of operational power available for the RF power transmitter 14, and the maximum amount of RF power needed to operate the RF power harvesting device(s) 12. These factors may be adjusted or modified to obtain the desired coverage area 38 needed in order to implement the RF power transmitting and RF power harvesting system 10.

It should be noted that the operational power for an RF power transmitter 14 and/or RF power network described in the invention herein may be derived from numerous AC or DC sources including, but not limited to, an AC power network, AC power grid 16, AC power main, DC power network, DC power grid 30, DC power main, telephone lines or jacks, Ethernet cable or jacks, cable network, or any other AC or DC source. The wiring for these sources may include, but is not limited to, building wire (10-2, 10-3, 12-2, 12-3, 14-2, 14-3), telephone wire, CAT-3, CAT-5, CAT-6, coaxial cable, or any other wiring or cable. The way to connect to these wires or to a device may include, but is not limited to, a 2-prong plug 82, 3-prong plug 82, DC power plug 82, vehicle cigarette lighter or power receptacle, RJ-45 connector, RJ-11 connector, F-type connector, screw-on plug 82 or connector, SMA connector, BNC connector, N-type connector, other coaxial connectors, USB connector, mini-USB connector, Firewire connector, product specific connectors, specialized connectors or any other type of connector, plug 82, or receptacle.

It will be understood by those skilled in the art that while the foregoing description sets forth in detail preferred embodiments of the present invention, modifications, additions, and changes might be made thereto without departing from the spirit and scope of the invention.

The invention claimed is:

1. A power transmission system for wirelessly powering a power harvesting device comprising:
at least one RF power transmitter; and
an AC power grid to which the transmitter is electrically connected.

2. A system as described in claim 1 wherein the power grid has an outlet.

3. A system as described in claim 2 wherein the transmitter has a cord which plugs into the outlet.

4. A system as described in claim 2 wherein the transmitter plugs directly into the outlet.

5. A system as described in claim 2 wherein the power grid has a light.

6. A system as described in claim 5 wherein the power grid has a light switch to turn on the light.

7. A system as described in claim 1 wherein the grid includes in wall wiring.

8. A system as described in claim 7 wherein the transmitter is integrated with the outlet.

9. A system as described in claim 2 wherein the grid has a lighting fixture and the transmitter contacts the fixture.

10. A system as described in claim 5 wherein the grid has a lighting fixture and one or the other of the light and the transmitter contact the fixture.

11. A system as described in claim 1 wherein the grid includes a utility pole to which the transmitter is in contact.

12. A system as described in claim 1 wherein the grid includes a junction box to which transmitter is in contact.

13. A system as described in claim 1 wherein the transmitter includes an AC to DC converter that can convert the AC power obtained from the grid to a usable DC voltage or current.

14. A power transmission system for wirelessly powering a power harvesting device comprising:
at least one RF power transmitter; and
a DC power grid to which the transmitter is electrically connected.

15. A system as described in claim 14 wherein the transmitter is disposed in a vehicle.

16. A system as described in claim 15 wherein the transmitter provides a coverage area over the cabin of the vehicle.

17. A system as described in claim 16 wherein the transmitter is in contact with the dash, trunk, cabin, ceiling, or engine compartment of the vehicle.

18. An adjustable RF power transmitter for powering wirelessly an RF power harvesting device comprising:
a housing having outer dimensions no greater than 3″×3″ by 8 inches;
a power input;
a frequency generator in communication with the power input;
an amplifier in communication with the frequency generator;
a controller connected with the frequency generator; and
an antenna connected to the amplifier.

19. A transmitter as described in claim 18 including a circuit board on which the power input, the frequency generator and the amplifier are disposed.

20. A transmitter as described in claim 19 including a heat sink in contact with the circuit board.

21. A transmitter as described in claim 20 including a fan disposed adjacent the circuit board.

22. A power transmission system for wirelessly powering an RF power harvesting device comprising:
a computer;
an antenna;
an RF transmitter in communication with the antenna and the computer; and
a power supply in electrical communication with the RF transmitter and the computer.

23. A system as described in claim 22 wherein the RF transmitter is disposed in the computer.

24. A system as described in claim 22 wherein the computer has a power port and the transmitter is plugged into the power port.

25. A system as described in claim 24 wherein the power port is a USB port.

26. A system as described in claim 22 wherein the antenna is integrated with the transmitter.

27. A system as described in claim 22 including a display, and the antenna is in contact with the display.

28. An apparatus for wirelessly powering a power harvesting device comprising:
at least one RF power transmitter; and
a lighting fixture to which the transmitter is connected and from which the transmitter receives power.

29. An apparatus as described in claim 28 wherein the lighting fixture is a fluorescent lighting fixture.

30. An apparatus as described in claim 28 wherein the lighting fixture is an incandescent lighting fixture.

31. An apparatus as described in claim 28 wherein the lighting fixture is an LED lighting fixture.

32. An apparatus as described in claim 28 including a light source in electrical communication with the lighting fixture.

33. A power transmission system for wirelessly powering a power harvesting device comprising:
at least one RF power transmitter; and
a track supplying power to which the transmitter is electrically connected.

34. A system as described in claim 33 wherein there are at least two power transmitters.

35. A system as described in claim 34 including at least two lights electrically connected to the track.

36. A system as described in claim 35 wherein the track includes a first conductor and a second conductor.

37. A system as described in claim 36 wherein the track includes a support attached to a wall or ceiling.

38. A power transmission system for wirelessly powering a power harvesting device comprising:
at least one RF power transmitter; and
a battery charging unit to which the transmitter is electrically connected.

39. A power transmission system for wirelessly powering a power harvesting device comprising:
at least one RF power transmitter; and
at least one rechargeable battery to which the transmitter is electrically connected.

40. A system as described in claim 39 including a second RF power transmitter which transmits power to the power harvesting device electronically connected to the battery.

41. A system as described in claim 40 including a valve sensor powered by a power harvesting device.

42. A method for wirelessly powering a power harvesting device comprising the steps of:
electrically connecting at least one RF power transmitter to an AC power grid; and
transmitting power with the RF power transmitter.

43. A method for wirelessly powering a power harvesting device comprising the steps of:
electrically connecting at least one RF power transmitter to a DC power grid; and
transmitting power with the RF power transmitter.

44. A method for wirelessly powering a power harvesting device comprising the steps of:
electrically connecting a power supply with an RF transmitter and a computer; and
transmitting power with the RF power transmitter.

45. A method for wirelessly powering a power harvesting device comprising the steps of:
electrically connecting at least one RF power transmitter with a lighting fixture to which the transmitter is in contact with and from which the transmitter receives power; and
transmitting power with the RF power transmitter.

46. A method for wirelessly powering a power harvesting device comprising the steps of:
electrically connecting at least one RF power transmitter to a battery charging unit; and
transmitting power with the RF power transmitter.

47. A power transmission system for wirelessly powering a power harvesting device comprising:
at least one RF power transmitter; and
means for providing power to which the transmitter is electrically connected.

48. An apparatus for wirelessly powering a power harvesting device from a DC power outlet of a vehicle comprising:
an RF power transmitter; and
a power plug to which the transmitter is attached and electrically connected that plugs into the DC power outlet.

49. A power transmission system for wirelessly powering an RF power harvesting device comprising:
an antenna;
an RF transmitter in communication with the antenna; and
a connector in communication with the RF transmitter and configured to be placed in communication with a device.

50. A system as described in claim 49, wherein the device is a computer.

51. A system as described in claim 49, wherein the connector is a USB connector.

52. An apparatus for wirelessly powering a power harvesting device from an AC power grid having an AC power outlet comprising:
an RF power transmitter; and
a power plug to which the transmitter is electrically connected that electrically connects with the AC power outlet.

53. An apparatus for wirelessly powering a power harvesting device from a DC power outlet of a DC grid comprising:
an RF power transmitter; and
a power plug to which the transmitter is electrically connected that electrically connects with the DC power outlet.

54. An apparatus for wirelessly powering a power harvesting device from a computer having an antenna and a power supply comprising:
an RF power transmitter; and
a power plug to which the transmitter is electrically connected that electrically connects with the computer.

55. An apparatus for wirelessly powering a power harvesting device from a light fixture comprising:
an RF power transmitter; and
an electrical interface to which the transmitter is electrically connected that electrically connects with the light fixture.

56. An apparatus for wirelessly powering a power harvesting device from a track having at least one light comprising:
an RF power transmitter; and
an electrical interface to which the transmitter is electrically connected that electrically connects with the track.

57. An apparatus for wirelessly powering a power harvesting device from a battery charging unit comprising:
an RF power transmitter; and
an electrical interface to which the transmitter is electrically connected that electrically connects with the battery charging unit.
